(19) United States
(12) Patent Application Publication
(10) Pub. No.: US 2007/0096369 A1
(43) Pub. Date: May 3, 2007

(54) Methods and apparatus for the separation of molded products from flexible mold pieces

(75) Inventors: Thadwick L. Webb, Ft. Lupton, CO (US); Aaron S. Webb, Ft. Lupton, CO (US); Steven L. Webb, Ft. Lupton, CO (US); David Tichenor, Brighton, CO (US); Brian M. Ryley, Lochbuie, CO (US)

Correspondence Address: SANTANGELO LAW OFFICES, P.C., 125 SOUTH HOWES, THIRD FLOOR, FORT COLLINS, CO, 80521, US

(73) Assignee: Fox Stone, Inc., Ft. Lupton, CO (US)

(21) Appl. No.: 11/265,705

(22) Filed: Nov. 1, 2005

(51) Int. Cl. B29C 41/42; B29C 55/02

(52) U.S. Cl. 264/334; 425/335; 425/383

(57) ABSTRACT

The inventive technology relates to methods and apparatus for the separation of molded products from flexible mold pieces and may include one or more of the following features: techniques for deforming molds, techniques for inducing tension in molds, techniques for providing movable mold deformation interfaces, techniques for connecting molds, techniques for distributing tension through molds, techniques for minimizing damage to molds, techniques for minimizing mold wear, techniques for utilizing large molds, techniques for curing molded materials in a space efficient manner, and techniques for forming molded products.

### BACKGROUND OF THE INVENTION

Generally, the inventive technology relates to the formation of molded products. Specifically, the inventive technology involves methods and apparatus for the separation of molded products from flexible mold pieces. The inventive technology may be particularly suited to the molding of manufactured stone products.

One widespread technique for the manufacture of fabricated products in contemporary industrial processes may be the use of pliable molding techniques. Pliable molding techniques may generally involve placing a pliable substance into a relatively more rigid mold and allowing the pliable substance to take the shape of the mold. The use of pliable molding techniques to fabricate products may be widespread in contemporary industry, perhaps representing a significant investment of manufacturing resources to a varied range of industrial applications.

For example, one industry that may heavily rely on pliable molding techniques may be the manufactured stone industry. Manufactured stone may be a product for use perhaps typically in building trades that is designed to simulate the look and feel of natural stone without its associated drawbacks, for example perhaps including the cost and weight of natural stone. Such manufactured stone may typically be poured material products that are formed into their final shape using specialized molds. The poured material used to create manufactured stone may include cement, sand, certain amounts of natural stone, pigments, and possibly other materials, perhaps typically combined in a fluid state that may lend itself to being poured into a mold. The molds used in the manufactured stone industry may range from basic shapes designed primarily to create a utilitarian product to highly sophisticated forms designed to replicate the appearance and texture of natural stone with a high degree of accuracy. Moreover, the demand for manufactured stone may be increasing as its benefits over natural stone in building processes may become more recognized and its ability to mimic natural stone increases.

A key step in typical pliable molding techniques may be removal of the molded product from the mold. More specifically, a pliable substance placed into a relatively more rigid mold may typically take the shape of the mold by being allowed to cure. Once cured, the mold generally must be stripped from the molded product. However, conventional techniques for stripping away molds may involve several disadvantages.

For example, one technique for stripping away molds that may be widely practiced may involve simply stripping away molds by hand. However, such use of manual labor may entail several inefficiencies. To accomplish hand stripping, significant personnel resources may require dedication to the hand stripping task that otherwise could be utilized elsewhere. Further, hand stripping may be a relatively slow and time consuming process, potentially reducing the output of molded products. It may also be that hand stripping may create fluctuations in the quality of the molded products based on discrepancies in the training and conscientiousness of individual workmen. The inefficiencies such as the foregoing may result in significant financial costs associated with stripping away molds by hand.

Moreover, while some automated stripping processes may have been developed, these also may come with their own disadvantages. For example, one automated technique for stripping away molds may involve vibrating molds to release the molded product. However, the stress created by vibration may adversely impact both the molds and the molded products. In the case of molds, the wear of repeated vibration over the course of many mold stripping events may reduce the useful life of the mold. In the case of molded products, the stress of vibration may cause damage to the molded product itself. Another automated technique for stripping away molds may involve the use of a rail or similar mechanical confinement to strip away a mold by bending. However, such confinement techniques may create wear on a mold at the confinement point over the course of repeated stripping events similar to that already described. Moreover, these kinds of confinement techniques may require additional steps to mitigate the frictional contact between the confinement device and the mold, such as lubrication or perhaps similar measures. The disadvantages associated with such automated stripping processes may entail associated financial costs, for example including the costs of replacing worn molds or the losses associated with damaged products.

Another disadvantage of conventional stripping processes may relate to mold sizes. For example, as a practical matter, conventional stripping processes may limit the maximum size of the mold that may be used. In particular, while larger mold sizes may be desirable to form more molded products per individual molding event, larger molds or molded products may be more delicate and therefore may be more prone to breaking, tearing, or other forms of structural degradation. This problem may be especially acute in automated stripping processes, where human judgment is not available to refine the handling of the mold so as to minimize the stress it is subjected to.

Conventional stripping processes may also entail disadvantages related to the efficient use of space and materials. For example, conventional stripping processes may require separate areas for placing a substance into a mold, allowing the substance to cure, and stripping the mold from the molded product. This may create inefficiencies related to transporting molds from one area to another, and may even result in some molds or some workspaces going unused at any given time, perhaps reducing the overall productivity of forming molded products.

A further disadvantage of conventional stripping processes may be that the work required to strip away a mold may only be brought to bear on a single mold at any given time. This may result in wasted work effort that otherwise may be able to be utilized perhaps by distributing some degree of the work required over multiple molds for any given stripping event.

The foregoing problems regarding conventional pliable molding techniques may represent a long-felt need for an effective solution to the same. While implementing elements may have been available, actual attempts to meet this need may have been lacking to some degree. This may have been due to a failure of those having ordinary skill in the art to fully appreciate or understand the nature of the problems and challenges involved. As a result of this lack of understanding, attempts to meet these long-felt needs may have failed to effectively solve one or more of the problems or challenges here identified. These attempts may even have led away from the technical directions taken by the present inventive technology and may even result in the achievements of the present inventive technology being considered to some degree an unexpected result of the approach taken.

### SUMMARY OF THE INVENTION

The inventive technology relates to methods and apparatus for the separation of molded products from flexible mold pieces and may include one or more of the following features: techniques for deforming molds, techniques for inducing tension in molds, techniques for providing movable mold deformation interfaces, techniques for connecting molds, techniques for distributing tension through molds, techniques for minimizing damage to molds, techniques for minimizing mold wear, techniques for utilizing large molds, techniques for curing molded materials in a space efficient manner, and techniques for forming molded products. Accordingly, the objects of the methods and apparatus for the separation of molded products from flexible mold pieces described herein address each of the foregoing problems in a practical manner. Naturally, further objects of the invention will become apparent from the description and drawings below.

### BRIEF DESCRIPTION OF THE DRAWINGS

FIG. 1 is an isometric view of a mold deformation apparatus.

FIG. 2 is an isometric view of a temporary molded material curing region.

FIG. 3 is an isometric view of a strap integrated through a flexible mold piece.

FIG. 4 is an isometric view of two linked flexible mold pieces.

FIG. 5 is an isometric view of two conveyors in stacked relation.

FIG. 6 is an isometric view of a heat conveyance element.

FIG. 7 is an isometric view of a mold material conveyance element.

### DETAILED DESCRIPTION OF THE PREFERRED EMBODIMENTS

The present inventive technology includes a variety of aspects, which may be combined in different ways. The following descriptions are provided to list elements and describe some of the embodiments of the present inventive technology. These elements are listed with initial embodiments, however it should be understood that they may be combined in any manner and in any number to create additional embodiments. The variously described examples and preferred embodiments should not be construed to limit the present inventive technology to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

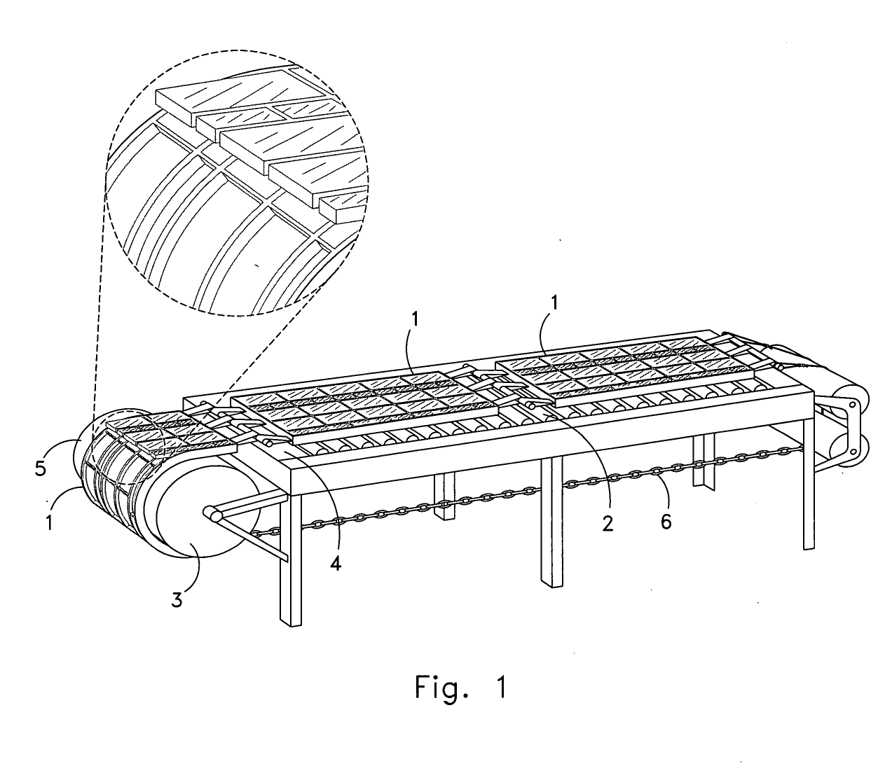

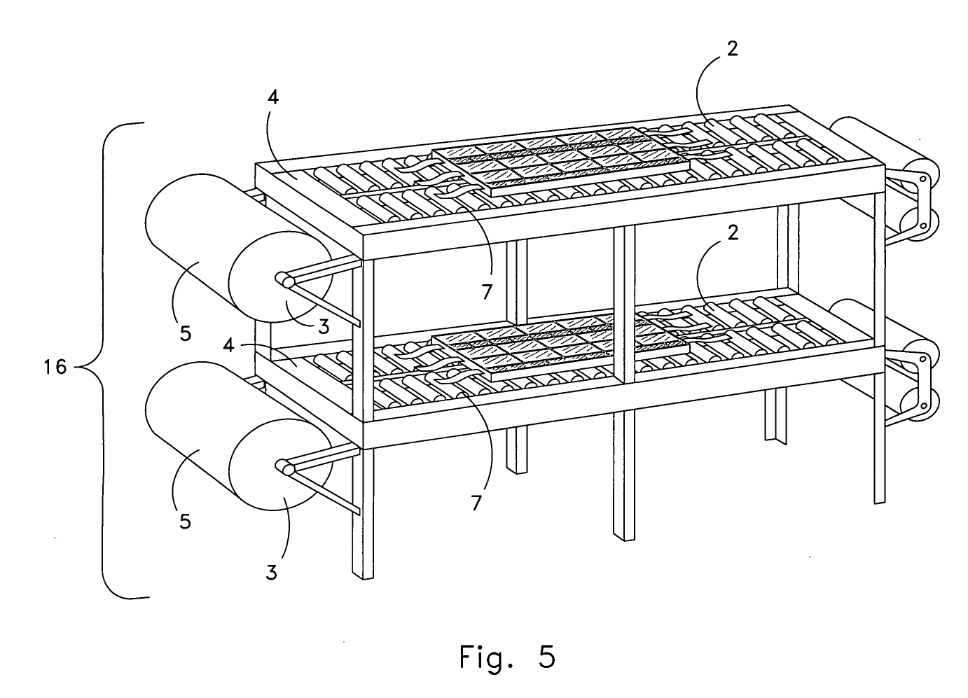

Referring now to FIGS. 1-7, certain embodiments of the inventive technology may include a mold deformation apparatus. A mold deformation apparatus may be an apparatus used to deform a mold piece (1), perhaps including a flexible mold piece. Accordingly, a mold deformation apparatus may include a mold piece reception area (2), perhaps including a flexible mold piece reception area, which may be understood to include an area of a mold deformation apparatus capable of receiving a mold piece (1). In some embodiments, a mold piece reception area (2) may be a conveyor element, which in various embodiments may include a powered conveyor element or perhaps even an unpowered conveyor element. The term powered may be understood to include directly driving a motion of a conveyor element, for example perhaps with an electric motor or internal combustion engine. The term unpowered may be understood to permit free movement of a conveyor element, perhaps in response to an external source of motion, without driving a motion of a conveyor element directly. Moreover, with specific reference primarily to FIG. 5, embodiments may include two or more conveyor belts arranged in stacked relation (16), which may include vertical stacked relation or perhaps even simply tiered one above another in various offset configurations.

A mold deformation apparatus may further include a molded material separation station. A molded material separation station may be an area at which a molded material is separated from a mold piece (1). In some embodiments, a molded material separation station may be an automated flexible mold piece deformation actuator (3). An automated flexible mold piece deformation actuator (3) may be an automated component that accomplishes deformation of a flexible mold piece. By the term automated, it may be understood that the deformation action itself may be accomplished by the action of an automated flexible mold piece deformation actuator (3) itself, perhaps particularly without significant human intervention. In some embodiments, an automated flexible mold piece deformation actuator (3) may include a deformation surface, perhaps even a curved deformation surface. A deformation surface may be understood to include a surface that deforms a flexible mold piece through either direct or indirect contact. For example, in some embodiments a curved deformation surface may include a curved panel or a cylindrical-shaped object such as a drum or a roller.

Some embodiments of the invention may include a movable deformation interface (5) joined to an automated flexible mold piece deformation actuator (3). A deformation interface may be understood to include a boundary between an automated flexible mold piece deformation actuator (3) and a flexible mold piece, perhaps formed by contact as during deformation. The term movable may be understood to include permitting a movement at a deformation interface, perhaps by moving an automated flexible mold piece deformation actuator (3) at the deformation interface, moving a flexible mold piece at the deformation interface, or even moving both an automated flexible mold piece deformation actuator (3) and a flexible mold piece at a deformation interface, perhaps in different directions with respect to each other. More particularly, in certain embodiments a movable deformation interface (5) may include a movable deformation surface, perhaps even a rotatable curved deformation surface such as a rotatable cylinder or rotatable drum. In this manner, it may be appreciated that deforming a flexible mold piece in one embodiment may involve rolling a flexible mold piece over the surface of a rotating cylinder or rotating drum. Moreover, in various embodiments a rotatable curved deformation surface may include a powered rotatable curved deformation surface or an unpowered rotatable curved deformation surface. The term powered may be understood to include directly driving a rotation of a rotatable curved deformation surface, for example perhaps with an electric motor or internal combustion engine. The term unpowered may be understood to permit free movement of a rotatable curved deformation surface, perhaps in response to an external source of motion, without driving a motion of a rotatable curved deformation surface directly.

A mold deformation apparatus may also include a mold piece positional establishment area (4), perhaps a flexible mold piece positional establishment area. A mold piece positional establishment area (4) may be an area that places a mold piece (1) into an optimal position to be acted upon by a molded material separation station, including perhaps an automated flexible mold piece deformation actuator (3). Such an optimal position may include, for example, positions that are coordinated in height, orientation, or other parameters by which a molded material separation station may act to separate a molded material from a mold piece (1). In some embodiments, a mold piece positional establishment area (4) may include a molded material separation station aligned mold piece positional establishment area, which may include a deformation surface aligned flexible mold piece positional establishment area. This may involve putting a mold piece positional establishment area (4) into a particular alignment with a molded material separation station so as to effect a desired optimal position of a mold piece (1). For example, in some embodiments a deformation surface aligned flexible mold piece positional establishment area may include the transition from a conveyor element to a rolling drum, wherein an end of such a conveyor element perhaps may be oriented in the direction of motion of such a rolling drum and the height of such a conveyor element may be sufficient to allow a flexible mold piece to become draped over such a rolling drum.

In some embodiments, various parts of a mold deformation apparatus may be responsive with respect to one another. By the term responsive, it may be understood that an action taken at one part of a mold deformation apparatus may result in an action occurring at another part of a mold deformation apparatus. For example, in some embodiments a mold piece reception area (2), perhaps including a flexible mold piece reception area, may be responsively located with respect to a mold piece positional establishment area (4), perhaps including a flexible mold piece positional establishment area. In some embodiments, this may perhaps include an arrangement that permits a mold piece (1) to be freely moved from a mold piece reception area (2) to a mold piece positional establishment area (4). Similarly, in some embodiments a molded material separation station, perhaps including an automated flexible mold piece deformation actuator (3), may be responsively located with respect to a mold piece positional establishment area (4), perhaps including flexible mold piece positional establishment area. In certain embodiments, this may include the ability of a molded material separation station to receive a positioned mold piece (1) from a mold piece positional establishment area (4), and in some embodiments may include the capability of an automated flexible mold piece deformation actuator (3) to subsequently act on a flexible mold piece that has been positioned by a flexible mold piece positional establishment area.

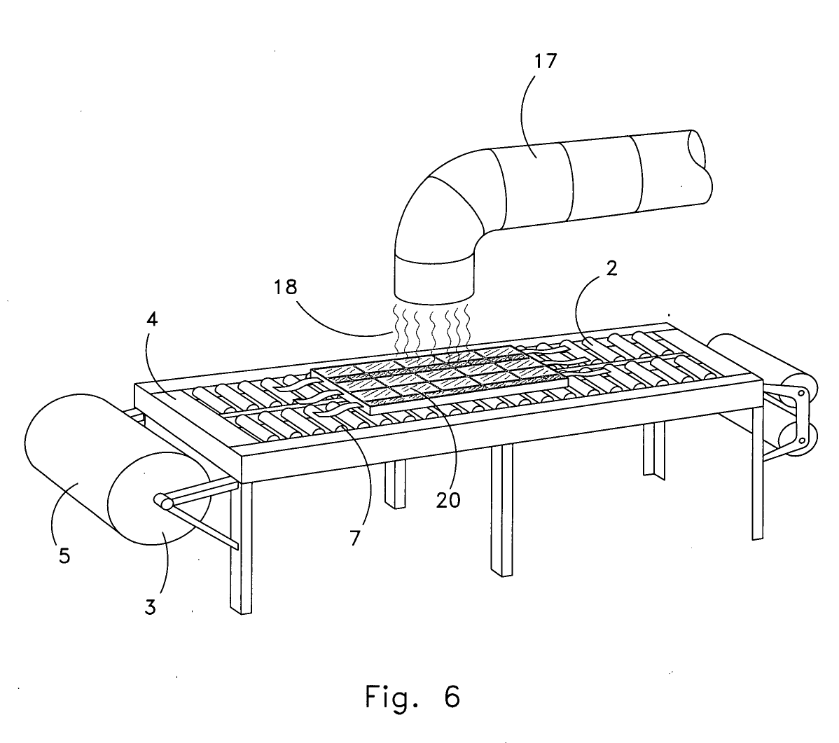

Now referring primarily to FIG. 6, a heat conveyance element (17) in some embodiments may be responsively located with respect to a mold piece reception area (2). A heat conveyance element (17) may include articles capable of moving heat (18) from a heat source to a location that is remote with respect to the heat source. By being perhaps responsively located with respect to a mold piece reception area (2), a heat conveyance element (17) may perhaps convey heat (18) from a heat source to a mold piece reception area (2). In various embodiments, a heat conveyance element (17) may include a fan, a radiator, or perhaps even a duct. In some embodiments, a heat conveyance element (17) may be used to provide heat (18) perhaps to decrease the curing time required for molded material added to a mold piece (1) located at a mold piece reception area (2).

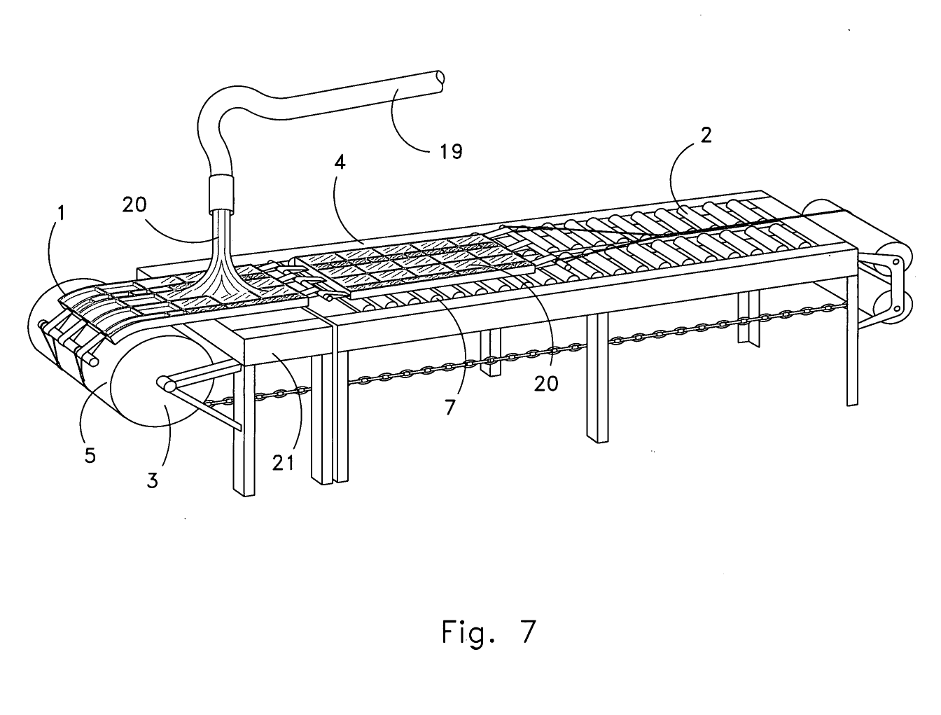

Now referring primarily to FIG. 7, various embodiments may also include a mold material conveyance element (19) responsively located with respect to a mold piece reception area (2). A mold material conveyance element (19) may include articles capable of moving a mold material (20) from one location to another location, perhaps including through pipes or tubes and perhaps with the aid of pumps or gravity. For example, in some embodiments, a mold material conveyance element (19) may be a cement pump. By being perhaps responsively located with respect to a mold piece reception area (2), a mold material conveyance element (19) may perhaps convey a mold material (20) to a mold piece (1) located at a mold piece reception area (2), perhaps so as to add a mold material (20) to a mold piece (1).

Moreover, embodiments may include a mold material vibration element (21). A mold material vibration element (21) may include items capable of vibrating a mold material (20) added to a mold piece (1) before such a mold material (20) has had a chance to cure. Such vibration of a mold material (20) prior to curing perhaps may allow the mold material (20) to evenly settle within a mold piece (1) and perhaps may allow air bubbles to be dislodged and removed from the added mold material (20), each potentially resulting in a higher quality molded end product. In various embodiments, a mold material vibration element (20) may include a vibrating surface, perhaps such as a vibrating table, vibrating conveyor belt, or even vibrating roller. Further, various embodiments may involve adding a mold material (20) to a mold piece (1) when the mold piece (1) is located at the mold material vibration element (21), or perhaps even prior to the mold piece (1) arriving at the mold material vibration element (21).

Now referring primarily to FIG. 1, some embodiments may include an automated flexible mold piece tension induction element (6). A tension induction element may be understood to include articles capable of inducing tension in a flexible mold piece. Moreover, the term automated may be understood to include the induction of tension by the action of a tension induction element itself, perhaps particularly without significant human intervention. An automated flexible mold piece tension induction element (6) may be adapted to act on a flexible mold piece placed within a flexible mold piece reception area. Stated differently, an automated flexible mold piece tension induction element (6) may exist on a mold deformation apparatus before a flexible mold piece is placed at a flexible mold piece reception area, and may perhaps only act on a flexible mold piece following its placement at a flexible mold piece reception area. In certain embodiments, an automated flexible mold piece tension induction element (6) may include a flexible tie. A flexible tie may be a tie having a degree of flexibility along its length. Examples of a flexible tie may include a chain, a cable, a strap, a rope, a filament, or a wire. In some embodiments, a flexible tie may be arranged to form a continuous loop about a flexible mold piece reception area, including perhaps over and underneath a flexible mold piece reception area. Moreover, some embodiments may include joining a flexible tie to a mold piece (1) and applying a tension to the flexible tie in order to distribute such a tension to a mold piece (1).

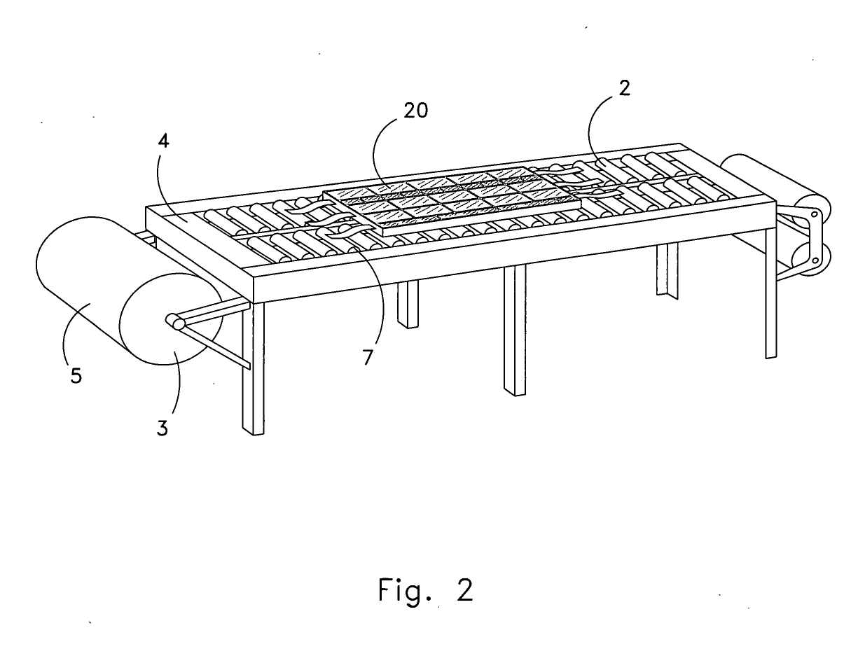

Now referring primarily to FIG. 2, in some embodiments a mold deformation apparatus may include a molded material curing apparatus. A molded material curing apparatus may include a temporary molded material curing region (7) integrated into a mold piece reception area (2). The term temporary molded material curing region (7) may be understood to include a region at which a molded material may be temporarily placed so as to permit substantial curing. Moreover, the term integrated may be understood to include a temporary molded material curing region (7) encompassed within a mold piece reception area (2) and requiring no additional components than those required to form the mold piece reception area (2). In various embodiments, a temporary molded material curing region (7) may include a surface of a mold piece reception area (2) or may perhaps be congruent with a mold piece reception area (2). The term congruent may be understood to include a temporary molded material curing region (7) that is the same as a mold piece reception area (2).

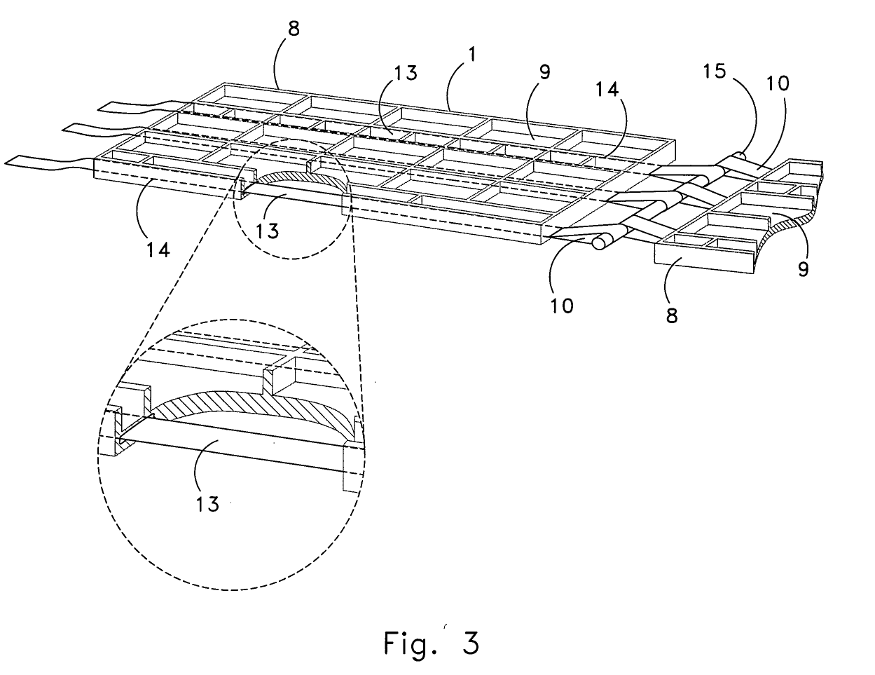

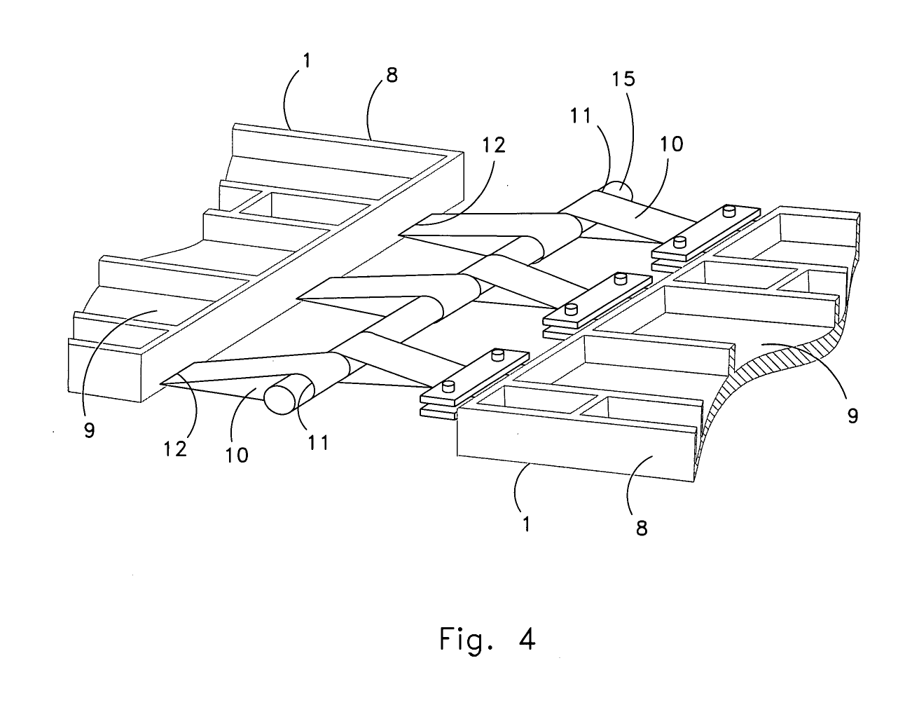

Now referring primarily to FIGS. 3-4, certain embodiments of the inventive technology may include a mold piece (1). A mold piece (1) may be an object to which a mold material (20) may be added, such that the mold material (20) is formed into a shape defined by the mold piece (1). In some embodiments, a mold piece (1) may include a structural substrate (8) and at least one mold zone (9) disposed on a structural substrate (8). A structural substrate (8) may be a component of a mold piece (1) that provides structural integrity to a mold piece (1). A mold zone (9) may be a component of a mold piece (1) that defines a shape to which an added mold material (20) may be formed, which may include in various embodiments perhaps a contiguous mold zone (9) or perhaps even a segmented mold zone (9). Moreover, a mold piece (1) in certain embodiments may include a flexible mold piece. A flexible mold piece may be a mold piece (1) having a degree of flexibility, which in some embodiments may be conferred by providing a flexible mold piece with a pliant structural substrate. Such a pliant structural substrate may be made of any suitably pliant material, including for example plastic, rubber, including perhaps two-part (prepolymer and curative) rubber, vinyl, or polyvinyl chloride.

At least one mold piece connection element (10) may be joined to a mold piece (1) in various embodiments, including perhaps being joined to a structural substrate (8) of a mold piece (1) or perhaps a tension bearing member of a mold piece (1). A mold piece connection element (10) may include any object capable of connecting two or more mold pieces (1). Examples of a mold piece connection element (10) may include hooks, crimps, clasps, rings, tongs, loops, magnets, glue, and mechanical fasteners. Moreover, in some embodiments a mold piece connection element (10) may include a flexible mold piece connection element, by which it may be understood that a mold piece connection element (10) may be capable of connecting two or more flexible mold pieces. Various embodiments also may include a quick-release mold piece connection element or a mateable mold piece connection element. By the term quick release, it may be understood that a mold piece connection element (10) may be capable of rapid connection and disconnection of mold pieces (1), which may include connection and disconnect times ranging from under 30 seconds, under 20 seconds, under 10 seconds, under 5 seconds, and perhaps even under 2 seconds. The term mateable may be understood to include a mold piece connection element (10) that effects connection by being shaped as a counterpart to another mold piece connection element (10).

A mold piece connection element (10) in some embodiments may include a mold piece connection interface (11) located at a first location of a mold piece connection element (10) and a mold piece joinder interface (12) located at a second location of a mold piece connection element (10). A mold piece connection interface (11) may be understood to include a boundary at which a mold piece connection element (10) accomplishes connection, including perhaps connection with another mold piece connection element (1) or perhaps even simply another mold piece (1). A mold piece joinder interface (12) may be understood to include a boundary at which a mold piece connection element (10) is joined to a mold piece (1). More particularly, various embodiments of a mold piece joinder interface (12) may include a surface of a structural substrate (8) or perhaps even an interior volume of a structural substrate (8).

Some embodiments may involve joining two or more mold pieces (1) together with one or more mold piece connection elements (10). For example, a first mold piece connection element (10) of a first mold piece (1) may be joined to a second mold piece connection element (10) of a second mold piece (1). Moreover, certain embodiments may involve joining an automated flexible mold piece tension induction element (6) to two or more joined mold pieces (1). For example, where two or more mold pieces (1) are joined together, an automated flexible mold piece tension induction element (6) may be joined to a force opposed location of such a first mold piece and a force opposed location of such a second mold piece. By the term force opposed, it may be understood that two or more locations may be force opposed when the vector sum of the forces applied at such locations adds up to zero. In the case of two mold pieces (1) joined together, for example, two force opposed locations may correspond to a location on a leading edge of such first mold piece (1) and a location on a trailing edge of said second mold piece (1), wherein each force opposed location is in line with the direction in which the force is applied.

In certain embodiments, a pliant structural substrate of a flexible mold piece may have a shore A hardness. In various embodiments, such a shore A hardness may range from about 10 to about 150.

Moreover, in certain embodiments, a pliant structural substrate of a flexible mold piece may have a low elastomeric modulus and at least one higher tensile strength tension bearing member (13) to which that pliant structural substrate is responsive. The term low elastomeric modulus may be understood to include an elastomeric modulus sufficient to permit the elasticity of a pliant structural substrate to allow flexure of a flexible mold piece while simultaneously allowing tension applied to a higher tensile strength tension bearing member (13) to be primarily born by that higher tensile strength tension bearing member (13). In various embodiments, a low elastomeric modulus may simply be an elastomeric modulus that is less than that of a higher tensile strength tension bearing member (13), which may include an elastomeric modulus that is less than 90%, less than 80%, less than 70%, less than 60%, less than 50%, less than 40%, less than 30%, less than 20%, or even less than 10% of that of a higher tensile strength tension bearing member (13).

In some embodiments, the term elastomeric modulus perhaps may be understood to represent a rating of force necessary to be applied to expansively deform a material to some degree, for example perhaps a rating of psi to expansively deform a material by 100%. Importantly, it should be understood that such a rating may yield different values for different degrees of expansive deformation, for example perhaps including lower psi values for degrees of deformation less than 100%, for example 50% deformation, 10% deformation, 5% deformation, or perhaps even less than 5% deformation. Accordingly, it may be appreciated that a material rated at a certain psi value for 100% deformation may indicate other psi values when converted for ratings indicative of either initial degrees of deformation or lower percentages of deformation than 100%, such as perhaps may be achieved by the current inventive technology with respect to an automated flexible mold piece deformation actuator (3), including perhaps as may be a result of drums or cylinders having varying radii lengths. In certain embodiments, a low elastomeric modulus perhaps may include such a psi rating to expansively deform a pliant structural substrate by a degree of 100% of less than about 150 psi, less than about 140 psi, less than about 130 psi, less than about 120 psi, less than about 110 psi, less than about 100 psi, less than about 90 psi, less than about 80 psi, less than about 70 psi, less than about 60 psi, or perhaps even less than about 50 psi. In certain embodiments, a low elastomeric modulus may be such a value of about 88 psi. Significantly, it may be appreciated that the actual degree of expansive deformation of a pliant structural substrate according to the inventive technology perhaps may be substantially less than 100%, including perhaps only to a degree of expansive deformation sufficient to release a molded product from a flexible mold piece, and that disclosure of a degree of force required to expansively deform a material by 100% may be understood perhaps to reflect only a rating of elasticity of modulus of such a material.

Moreover, in various embodiments, a low elastomeric modulus pliant structural substrate may have an ultimate tensile strength. Such an ultimate tensile strength may be understood to include the number of psi that may be applied to a low elastomeric modulus pliant structural substrate until such a low elastomeric modulus pliant structural substrate disintegrates. In various embodiments, an ultimate tensile strength of a pliant structural substrate may be less than about 1200 psi, less than about 1100 psi, less than about 1000 psi, less than about 900 psi, less than about 800 psi, less than about 700 psi, or perhaps even less than about 600 psi. In certain embodiments, an ultimate tensile strength of a low elastomeric modulus pliant structural substrate may be about 907 psi. Moreover, in certain embodiments a pliant structural substrate may have the properties of a Cured Por-A-Mold SX30-1 supplied by Hyperlast North America, Chattanooga, Tenn., USA.

A tension bearing member may be understood to include an object that when joined to a pliant structural substrate is capable of bearing an applied tension substantially without transmitting said applied tension to that pliant structural substrate. A tension bearing member to which a pliant structural substrate is responsive may be understood to include any such member to which an applied tension creates a responsive effect in that pliant structural substrate. Such responsive effects may include, for example, changing a shape, density, or rigidity of a pliant structural substrate. Importantly, it should be understood that such responsive effects may be caused by a changing condition of a tension bearing member due to a tensile force applied to that tension bearing member, and may not be caused directly by the applied tensile force.

Moreover, the term higher tensile strength may be understood to include a tensile strength that is sufficient to permit a tensile force applied to a higher tensile strength tension bearing member (13) to be born primarily by that higher tensile strength tension bearing member (13), and perhaps to minimize transmission of that tensile force to a pliant structural substrate. In various embodiments, a higher tensile strength perhaps may simply be a tensile strength that is higher than that of a low elastomeric modulus pliant structural substrate, which may include a tensile strength that is more than 110%, more than 120%, more than 130%, more than 140%, more than 150%, more than 160%, more than 170%, more than 180%, more than 190%, or even more than 200% of that of a low elastomeric modulus pliant structural substrate. In some embodiments, a higher tensile strength perhaps may be a psi value of a higher tensile strength tension bearing member (13) that is greater than about 50 psi, greater than about 100 psi, greater than about 200 psi, greater than about 300 psi, greater than about 400 psi, greater than about 500 psi, greater than about 600 psi, greater than about 700 psi, greater than about 800 psi, greater than about 900 psi, greater than about 1000 psi, greater than about 1100 psi, greater than about 1200 psi, greater than about 1300 psi, greater than about 1400 psi, greater than about 1500 psi, greater than about 1600 psi, greater than about 1700 psi, greater than about 1800 psi, greater than about 1900 psi, or perhaps even greater than about 2000 psi.

Certain embodiments also may include a disintegration prevention interface (14) disposed between a low elastomeric modulus pliant structural substrate and a higher tensile strength tension bearing member (13). Such a disintegration prevention interface may be understood to include an interface that prevents a tensile force applied to a higher tensile strength tension bearing member (13) from causing a pliant structural substrate to disintegrate. The term disintegrate should be understood to include a variety of adverse impacts to the structural integrity of a pliant structural substrate, including for example breaks, rips, or tears. In some embodiments, a disintegration prevention interface (14) may simply be a boundary between a low elastomeric modulus pliant structural substrate and a higher tensile strength tension bearing member (13), where the difference in tensile strength across such a boundary may prevent a tensile force applied to the higher tensile strength tension bearing member (13) from being transmitted to the low elastomeric modulus pliant structural substrate.

At least one mold zone (9) may be disposed on a low elastomeric modulus pliant structural substrate in various embodiments. Moreover, in some embodiments such a mold zone (9) may include a large mold zone (9). The term large may be understood to include a mold zone (9) established on a flexible mold piece of such a size that would tend to disintegrate under the pressure of a directly applied tensile force. In certain embodiments, a large mold zone (9) may be a mold zone having a width dimension greater than 3 feet and a length dimension greater than 5 feet.

A higher tensile strength tension bearing member (13) in some embodiments may involve a strap joined to a pliant structural substrate. Such a strap may be understood to include any narrow strip of flexible material capable of bearing a tension, such as a length of nylon, rope, plastic, rubber, fiber, or perhaps even metal. Moreover, in certain embodiments, a strap joined to a pliant structural substrate may involve a strap integrated through a pliant structural substrate, which may be understood to include at least a portion of such a strap being wholly encompassed within such a pliant structural substrate. Examples of a strap integrated through a pliant structural substrate may include one end of a strap embedded within such a pliant structural substrate or perhaps even a middle section of a strap embedded within such a pliant structural substrate with two free ends. Some embodiments may involve the use of a strap as described rated at about 15,000 pounds.

Certain embodiments may involve joining a mold piece connection element (10) to a higher tensile strength tension bearing member (13), which may include for example joining a mold piece connection element (10) to a strap joined a to pliant structural substrate. In some embodiments, such a mold piece connection element (10) may include a loop end formed by such a strap, perhaps by reversing an end of such a strap upon itself to form a loop. Moreover, some embodiments may involve joining at least two mold pieces (1) together by aligning a first loop end of a first mold piece (1) with a second loop end of a second mold piece (1) and placing a connection bar (15) through each respective loop.

Moreover, various embodiments may include an automated flexible mold piece tension induction element (6) joined to at least one higher tensile strength tension bearing member (13). In certain embodiments, this may involve joining such an automated flexible mold piece tension induction element (6) to a mold piece connection element (10) joined to a strap, perhaps even including where such a mold piece connection element (10) may be connection bar (15) placed through the respective loops of one or more loop ends.

Now with further reference to FIGS. 1-7, embodiments of the inventive technology may include a method for deforming mold. Such a method may include defining a mold zone (9). The term defining may be understood to include demarcating a definition of a mold zone (9), which in some embodiments may include establishing a mold zone (9) on a mold piece (1), perhaps including a flexible mold piece. Various embodiments may further involve establishing a mold zone (9) in an initial geometric configuration. An initial geometric configuration may be understood to include a configuration of a mold zone (9) prior to any subsequent reconfiguration step. In some embodiments, an initial geometric configuration may include a substantially planar configuration, for example as when a flexible mold piece may be placed on a substantially planar surface of a mold piece reception area (2) such as a conveyor element.

Some embodiments may include automatically applying a geometric reconfiguration force to a mold zone. By the term automatically, it may be understood that the direct application of a geometric reconfiguration force to a mold zone (9) may be accomplished without significant human intervention. A geometric reconfiguration force may be understood to include a force that alters an initial geometric configuration of a mold zone (9) into an altered geometric configuration. Accordingly, a method for deforming a mold may include altering an initial geometric configuration of a mold zone (9) as a function of an automatically applied geometric reconfiguration force. The term altering may be understood to include creating alterations in the geometric configuration of a mold zone (9) perhaps such as bending, flexing, or warping. Moreover, automatically applying a geometric reconfiguration force in various embodiments may include deforming a mold zone (9), for example perhaps by conforming a mold zone (9) to a deformation surface or even a curved deformation surface. In certain embodiments, automatically applying a geometric reconfiguration force to a mold zone (9) may be accomplished with an automatic flexible mold piece deformation actuator (3).

Automatically applying a geometric reconfiguration force in some embodiments may include automatically applying a geometric reconfiguration force at a location of a mold zone (9) and moving such location. The term moving such location may be understood to include moving the location at which a geometric reconfiguration force is applied to a mold zone (9) in any dimension. For example, some embodiments may involve moving such a location at a deformation interface. In various embodiments, this may include generating a differential motion at a deformation interface or perhaps even a concurrent motion at a deformation interface. The term differential motion may be understood to include moving a mold zone (9) in a different direction from that of an applied geometric reconfiguration force, for example including perhaps moving a mold zone (9) established on a flexible mold piece over a stationary deformation surface. The term concurrent motion may be understood to include moving a mold zone (9) in the same direction as that of an applied geometric reconfiguration force, for example including perhaps moving a mold zone (9) established on a flexible mold piece over a movable deformation surface. Moreover, in various embodiments a deformation surface may include a curved deformation surface, and moving a location at which a geometric reconfiguration force is applied may include rotating such a curved deformation surface. For example, some embodiments may include deforming a flexible mold piece by rolling such a flexible mold piece over the surface of a rotating drum. The term rotating may be understood to include driving a rotation of a curved deformation surface, for example perhaps with an electric motor or an internal combustion engine, as well as permitting a free rotation of a curved deformation surface, for example perhaps in response to an external source of motion without driving a rotation directly.

Now with further reference to FIG. 2, some embodiments may include adding a mold material (20) to a mold zone (9). A mold material (20) may be understood to include any material capable of being formed by a mold zone (9) and cured into a molded product. Examples of a mold material (20) in some embodiments may include cement, plastic, silicone, or urethane. Some embodiments may further involve separating a cured molded material from a mold zone (9). The term cured may be understood to include a substantially dry and hardened molded material. Examples of cured molded materials may perhaps include building blocks, artificial stones, or tile.

In some embodiments, adding a mold material (20) to a mold zone (9) may include adding a mold material (20) to a mold zone (9) in an initial geometric configuration. In this manner, it may be appreciated that a cured molded material may have a form defined by such a mold zone (9) in such an initial geometric configuration. Moreover, separating a cured molded material may involve automatically applying a geometric reconfiguration force to a mold zone (9), for example perhaps to bend, flex, or warp such a mold zone (9). Because a cured molded material may tend to retain the shape in which it was formed, for example, the shape of a mold zone (9) in an initial geometric configuration, altering an initial geometric configuration of a mold zone (9) may be understood to release such a cured molded material from a mold zone (9). Accordingly, some embodiments may involve removing a molded material from a mold zone (9), perhaps including releasing a molded material from a mold zone (9) in the foregoing manner, and forming a molded product. This may include in certain embodiments rolling a flexible mold piece over a rotating drum and ejecting a molded material from such a flexible mold piece as the flexible mold piece takes the shape of the surface of the rotating drum.

Various embodiments may include situating a mold zone (9) at a delivery path location with respect to a molded material separation station. A delivery path location may be understood to include a location from which a mold zone (9) may be moved along a direct path to a molded material separation station. Moreover, in certain embodiments, a delivery path location may include a conveyor element location. A conveyor element location may be understood to include a location from which a mold zone (9) may be moved along a conveyor element directly to a molded material separation station. In various embodiments, such a conveyor element may include a powered conveyor element or an unpowered conveyor element. With further reference primarily to FIG. 5, certain embodiments may perhaps even include two or more conveyor belts arranged in stacked relation (16), and further involve situating a first mold zone (9) at a lower conveyor element location and a second mold zone (9) at an upper conveyor element location.

Certain embodiments may involve allowing a mold material (20) added to a mold zone (9) to cure at a delivery path location. In some embodiments, this may include allowing such curing to occur at a temporary molded material curing region (7) integrated into a mold piece reception area (2). Moreover, certain embodiments may involve moving a mold zone (9) to a molded material separation station along a delivery path, returning such a mold zone (9) along the same delivery path to the same delivery path location, and refilling such a mold zone (9) with a mold material (20). In this manner it may be understood that a single delivery path and delivery path location may serve to permit adding a mold material (20) to a mold zone (9), allowing such added mold material (20) to form into a cured molded material, and removing said cured molded material from a mold zone (9). Additionally, it may be seen that the same mold zone (9) and the same molded material separation station may be reused in conjunction with such a single delivery path and delivery path location.

With further reference primarily to FIG. 7, adding a mold material (20) to a mold zone (9) and refilling a mold zone (9) with a mold material (20) in certain embodiments may include conveying a mold material (20) to a delivery path location, for example perhaps with a mold material conveyance element (19). Moreover, various embodiments may include vibrating a mold material (20) with a mold material vibration element (21) before such a mold material (20) has had a chance to cure. Additionally, with further reference primarily to FIG. 6, certain embodiments may involve conveying heat (18) to a delivery path location, for example perhaps with a heat conveyance element (17).

Now with further reference primarily to FIGS. 3-4, various embodiments may include defining a first mold zone (9) and a second mold zone (9), which may perhaps include establishing a first mold zone (9) on a first flexible mold piece and establishing a second mold zone (9) on a second flexible mold piece. Moreover, a first mold zone (9) and a second mold zone (9) may be linked in a motion coordinated modality. Linking in a motion coordinated modality may be understood to include providing a link between a first mold zone (9) and a second mold zone (9) that permits a movement of each said mold zone (9) that is coordinated to a movement of the other said mold zone (9). Embodiments also may include initiating a coordinated motion of said first mold zone (9) linked to said second mold zone (9). Initiating such a coordinated motion may be understood to include initiating a motion of such a first mold zone (9) and generating a motion of such a second mold zone (9) as a function of said initiated motion of said first mold zone (9).

In some embodiments, linking a first mold zone (9) to a second mold zone (9) in a motion coordinated modality may include establishing a motion responsive physical connection between a first flexible mold piece and a second flexible mold piece. Such a motion responsive physical connection may be understood to include any physical connection between each such flexible mold piece that creates a motion in one such flexible mold piece as a result of a motion in the other such flexible mold piece. For example, a motion responsive physical connection in some embodiments may include a motive force transfer point between each said flexible mold piece. A motive force may be understood to include any force that tends to induce a motion in an object, and a motive force transfer point may include any point that facilitates transmission of a motive force from one object to another object. Accordingly, in certain embodiments, initiating a coordinated motion of a first mold zone (9) and a second mold zone (9) may involve applying a motive force to a first flexible mold piece, transmitting said motive force to a second flexible mold piece through a motive force transfer point, and moving such a second flexible mold piece.

Various embodiments may involve distributing tension through a mold zone (9). In some embodiments, this may include applying a tensile force through a first mold zone (9) and applying a tensile force through a second mold zone (9). While it may be appreciated that such an application of tensile force may be accomplished in a variety of ways, certain examples of this may perhaps include applying a first opposed tensile force at an opposed force location of a first mold zone (9), applying a second opposed tensile force at an opposed force location of a second mold zone (9), and distributing such first opposed tensile force and such second opposed tensile force through such linked first mold zone (9) and such linked second mold zone (9). By the term opposed tensile force, it may be understood that two or more tensile forces are opposed when their vector sums add up to zero. Moreover, some embodiments may involve applying a tensile force with a tension induction element.

In certain embodiments, distributing tension through a mold zone (9) may include establishing at least one tension bearing member to which such a mold zone (9) is responsive, for example including perhaps a higher tensile strength tension bearing member (13). The term responsive may be understood to include inducing an effect in a mold zone (9) as a response to a changed condition in a tension bearing member. In certain embodiments, establishing a tension bearing member may include joining a strap to a flexible mold piece, or perhaps even integrating a strap through a flexible mold piece.

In some embodiments, a tensile force may be applied to a tension bearing member. This may be understood to include subjecting at least some points contained within such a tension bearing member to the effects of such an applied tensile force. Such effects may include perhaps laterally expanding the space between any given points contained with such a tension bearing member or possibly increasing a rigidity of such a tension bearing member. Accordingly, various embodiments may include altering a tension parameter of such a tension bearing member, for example including perhaps by increasing a tension of such a tension bearing member. Moreover, to the extent that a mold zone (9) may be responsive to a tension bearing member, applying a tensile force to a tension bearing member may correspondingly alter a tension parameter of such a mold zone (9). For example, such corresponding alteration may include perhaps laterally expanding the space between any given points contained with such a mold zone (9), increasing the rigidity of such a mold zone (9), or possibly even increasing a tension of such a mold zone (9). Accordingly, it may be appreciated that certain embodiments may involve affecting a mold zone (9) as a function of a tensile force applied to a tension bearing member.

Further, some embodiments may involve minimizing a stress potential to a mold zone (9) generated by an applied tensile force. The term stress potential may be understood to include an increased degree of stress to which a mold zone (9) may be subjected as a result of such an applied tensile force. Minimizing a stress potential may be accomplished in a variety of ways according to various embodiments of the invention. For example, a stress potential may be minimized perhaps by preventing a disintegration of a mold zone (9). Minimizing a stress potential perhaps may also involve primarily bearing an applied tensile force through a tension bearing member. The term primarily bearing may be understood to include permitting only a minimal transmission of an applied tensile force from a tension bearing member to a mold zone (9) that may be responsive to such a tension bearing member. A stress potential perhaps also may be minimized by establishing an elastomeric modulus of a pliant structural substrate of a flexible mold piece that is less than an elastomeric modulus of a tension bearing member, or perhaps by establishing a tensile strength of a tension bearing member that is higher than a tensile strength of a pliant structural substrate of a flexible mold piece. Such an elastomeric modulus in certain embodiments indeed may be a low elastomeric modulus, and such a tensile strength in certain embodiments indeed may be a higher tensile strength.

Certain embodiments may involve joining a mold piece connection element (10) to a mold piece (1), which may perhaps include a flexible mold piece connection element, a quick release mold piece connection element, or possibly even a mateable mold piece connection element. Moreover, establishing a motion responsive physical connection between a first flexible mold piece and a second flexible mold piece in some embodiments may involve joining each such flexible mold piece with a mold piece connection element (10). In some embodiments, a mold piece connection element (10) may perhaps include a loop end formed by a strap joined to a flexible mold piece, and joining a first flexible mold piece to a second flexible mold piece may include aligning two or more loop ends formed by straps joined to each such flexible mold piece and placing a connection bar (15) through each said loop end.

Several advantages may attend the inventive technology as described herein. One advantage may be to reduce or perhaps eliminate the manual labor associated with stripping molds by hand. This may free up personnel resources for dedication to other tasks. Further, the elimination of manual labor may decrease the time required to strip any individual mold, perhaps potentially increasing the output of molded products. Also, the elimination of manual labor perhaps may create a consistent quality product by eliminating quality fluctuations due to discrepancies in the training and conscientiousness of individual workmen. Additionally, the elimination of manual labor may promote increased safety by reducing the opportunities for injury associated with stripping molds by hand. The efficiencies associated with the foregoing may result in significant financial savings over comparable hand stripping processes.

Moreover, the inventive technology described herein may represent a substantial improvement over prior automated stripping processes. For example, vibration need not be employed to strip away a mold, thereby potentially eliminating the drawbacks associated with such techniques. Similarly, mechanical confinements such as rails need not be utilized, again potentially eliminating the drawbacks associated with such processes. Indeed, the present inventive technology may significantly reduce the stress and wear to which molds may be subjected, for example perhaps by reducing or eliminating abrasive contact points with mold pieces, thereby potentially extending the useful life of such molds. These advantages also may result in significant financial savings realized compared to prior automated stripping processes.

A further advantage of the inventive technology described herein may be the ability to utilize larger molds. In particular, the present inventive technology may represent a significant advance in the ability to distribute tension within a mold, for example perhaps by distributing tension through a tension bearing member. As a result, larger molds may be utilized with the present inventive technology, whereas the stresses associated with prior techniques may have damaged comparably sized larger molds. In turn, the ability to use larger molds perhaps may contribute to an increased overall output of molded products.

The present inventive technology may also provide advantages related to the efficient use of space and materials. In particular, the ability to form, cure, and strip molds using a common delivery path may save space and reduce the number of molds required to efficiently carry out a molding operation.

In addition, the present inventive technology may create further efficiencies by distributing the work required to strip a mold over several molds at a time. More specifically, aspects of the inventive technology related to joining multiple molds together and distributing tension through multiple joined molds may eliminate certain duplicate efforts perhaps required when each individual mold requires a separate stripping event.

As may be easily understood from the foregoing, the basic concepts of the present invention may be embodied in a variety of ways. It involves both molding techniques as well as devices to accomplish the appropriate molding. In this application, the molding techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this patent application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “mold” should be understood to encompass disclosure of the act of “molding”—whether explicitly discussed or not—and, conversely, were there effectively disclosure of the act of “molding”, such a disclosure should be understood to encompass disclosure of a “mold” and even a “means for molding”. Such changes and alternative terms are to be understood to be explicitly included in the description.

Any patents, publications, or other references mentioned in this application for patent are hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in Information Disclosure Statement or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the molding devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, and xii) each potentially dependent claim or concept as a dependency on each and every one of the independent claims or concepts presented.

With regard to claims whether now or later presented for examination, it should be understood that for practical reasons and so as to avoid great expansion of the examination burden, the applicant may at any time present only initial claims or perhaps only initial claims with only initial dependencies. Support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A mold deformation apparatus comprising:
a flexible mold piece reception area;
a temporary molded material curing region integrated into said flexible mold piece reception area;
an automated flexible mold piece tension induction element adapted to act on a flexible mold piece placed within said flexible mold piece reception area;
a flexible mold piece positional establishment area to which said flexible mold piece reception area is responsively located;
an automated flexible mold piece deformation actuator responsive with respect to said flexible mold piece positional establishment area; and
a movable deformation interface joined to said automated flexible mold piece deformation actuator.

2. A mold deformation apparatus as described in claim 1, wherein said flexible mold piece reception area comprises a conveyor element.

3. A mold deformation apparatus as described in claim 1, wherein said automated flexible mold piece tension induction element comprises a flexible tie.

4. A mold deformation apparatus as described in claim 1, wherein said automated flexible mold piece deformation actuator comprises a deformation surface.

5. A mold deformation apparatus as described in claim 4, wherein said deformation surface comprises a curved deformation surface.

6. A mold deformation apparatus as described in claim 1, wherein said movable deformation interface comprises a movable deformation surface.

7. A mold deformation apparatus as described in claim 6, wherein said movable deformation surface comprises a rotatable curved deformation surface.

8. A mold deformation apparatus as described in claim 1, wherein said temporary molded material curing region integrated into said flexible mold piece reception area comprises a temporary molded material curing region congruent with said flexible mold piece reception area.

9. A mold deformation apparatus as described in claim 1, further comprising at least one flexible mold piece located at said flexible mold piece reception area, and wherein said flexible mold piece comprises:
a low elastomeric modulus pliant structural substrate;
at least one higher tensile strength tension bearing member to which said low elastomeric modulus pliant structural substrate is responsive; and
a disintegration prevention interface disposed between said low elastomeric modulus pliant structural substrate and said at least one higher tensile strength tension bearing member.

10. A mold deformation apparatus as described in claim 9, wherein said automated flexible mold piece tension induction element is joined to said at least one higher tensile strength tension bearing member.

11. A mold deformation apparatus as described in claim 9, further comprising at least one mold piece connection element joined to said low elastomeric modulus pliant structural substrate.

12. A mold deformation apparatus as described in claim 11, further comprising a first said mold piece connection element of a first said flexible mold piece joined to a second said mold piece connection element of a second said flexible mold piece.

13. A method for deforming a mold comprising the steps of:
defining a mold zone;
establishing at least one tension bearing member to which said mold zone is responsive;
applying a tensile force to said at least one tension bearing member;
altering a tension parameter of said at least one tension bearing member;
correspondingly altering a tension parameter of said mold zone;
affecting said mold zone as a function of said tensile force applied to said at least one tension bearing member;
minimizing a stress potential to said mold zone generated by said applied tensile force;
establishing said affected mold zone in an initial geometric configuration;
automatically applying a geometric reconfiguration force to said affected mold zone at a location of said mold zone;
moving said location at which said geometric reconfiguration force is automatically applied; and
altering said initial geometric configuration of said affected mold zone as a function of said automatically applied geometric reconfiguration force.

14. A method for deforming a mold as described in claim 13, further comprising the step of situating said mold zone at a conveyor element location.

15. A method for deforming a mold as described in claim 13, wherein said step of applying a tensile force to said at least one tension bearing member comprises the steps of:
joining a flexible tie to said at least one tension bearing member; and
applying a lateral force through said flexible tie.

16. A method for deforming a mold as described in claim 13, wherein said step of automatically applying a geometric reconfiguration force to said affected mold zone at a location of said mold zone comprises the step of deforming said mold zone.

17. A method for deforming a mold as described in claim 16, wherein said step of deforming said mold zone comprises the step of conforming said mold zone to a deformation surface.

18. A method for deforming a mold as described in claim 17, wherein said step of conforming said mold zone to a deformation surface comprises the step of conforming said mold zone to a curved deformation surface.

19. A method for deforming a mold as described in claim 13, wherein said step of moving said location at which said geometric reconfiguration force is automatically applied comprises the step of moving said location at a deformation interface.

20. A method for deforming a mold as described in claim 19, wherein said step of moving said location at a deformation interface comprises the step of moving said location about a curved deformation surface.

21. A method for deforming a mold as described in claim 20, wherein said step of moving said location about a curved deformation surface comprises the step of rotating said curved deformation surface.

22. A method for deforming a mold as described in claim 13, wherein said step of defining a mold zone comprises the steps of defining a first mold zone and defining a second mold zone and further comprising the steps of:
linking said first mold zone to said second mold zone in a motion coordinated modality; and
initiating a coordinated motion of said first mold zone and said second mold zone.

23. A method for deforming a mold as described in claim 22, wherein said step of linking said first mold zone to said second mold zone in a motion coordinated modality comprises the step of establishing a motion responsive physical connection between said first mold zone and said second mold zone.

24. A method for deforming a mold as described in claim 23, wherein said step of initiating a coordinated motion of said first mold zone and said second mold zone comprises the steps of:
applying a motive force to said first mold zone;
transmitting said motive force to said second mold zone through said motion responsive physical connection; and
moving said second mold zone.

25. A method for deforming a mold as described in claim 14, wherein said step of defining a mold zone comprises the step of establishing said mold zone on a flexible mold piece, and wherein said step of establishing at least one tension bearing member to which said mold zone is responsive comprises the step of integrating a strap through said flexible mold piece.

26. A method for deforming a mold as described in claim 13, wherein said step of minimizing a stress potential to said mold zone generated by said applied tensile force comprises the step of primarily bearing said applied tensile force through said at least one tension bearing member.

27. A method for deforming a mold as described in claim 13, further comprising the steps of:
adding a mold material to said mold zone;
situating said mold zone at a delivery path location with respect to a molded material separation station; and
allowing said molded material to cure at said delivery path location.

28. A mold deformation apparatus comprising:
a flexible mold piece reception area;
an automated flexible mold piece tension induction element adapted to act on a flexible mold piece placed within said flexible mold piece reception area;
a flexible mold piece positional establishment area to which said flexible mold piece reception area is responsively located;
an automated flexible mold piece deformation actuator responsive with respect to said flexible mold piece positional establishment area.

29. A mold deformation apparatus as described in claim 28, wherein said flexible mold piece reception area comprises a conveyor element.

30. A mold deformation apparatus as described in claim 29, wherein said conveyor element comprises at least two conveyor elements arranged in stacked relation.

31. A mold deformation apparatus as described in claim 29, wherein said conveyor element comprises a powered conveyor element.

32. A mold deformation apparatus as described in claim 29, wherein said conveyor element comprises an unpowered conveyor element.

33. A mold deformation apparatus as described in claim 28, wherein said automated flexible mold piece tension induction element comprises a flexible tie.

34. A mold deformation apparatus as described in claim 33, wherein said flexible tie comprises a flexible tie selected from the group consisting of a chain, a cable, a strap, a rope, a filament, and a wire.

35. A mold deformation apparatus as described in claim 33, wherein said flexible tie forms a continuous loop about said flexible mold piece reception area.

36. A mold deformation apparatus as described in claim 28, wherein said automated flexible mold piece deformation actuator comprises a deformation surface.

37. A mold deformation apparatus as described in claim 36, wherein said deformation surface comprises a curved deformation surface.

38. A mold deformation apparatus as described in claim 28, further comprising a movable deformation interface joined to said automated flexible mold piece deformation actuator.

39. A mold deformation apparatus as described in claim 38, wherein said movable deformation interface comprises a movable deformation surface.

40. A mold deformation apparatus as described in claim 39, wherein said movable deformation surface comprises a rotatable curved deformation surface.

41. A mold deformation apparatus as described in claim 40, wherein said rotatable curved deformation surface comprises a powered rotatable curved deformation surface.

42. A mold deformation apparatus as described in claim 40, wherein said rotatable curved deformation surface comprises an unpowered rotatable curved deformation surface.

43. A mold deformation apparatus as described in claim 36, wherein said flexible mold piece positional establishment area comprises a deformation surface aligned flexible mold piece positional establishment area.

44. A mold deformation apparatus as described in claim 28, further comprising a heat conveyance element responsively located with respect to said flexible mold piece reception area.

45. A mold deformation apparatus as described in claim 28, further comprising a mold material conveyance element responsively located with respect to said flexible mold piece reception area.

46. A mold deformation apparatus as described in claim 28, further comprising a flexible mold piece located at said automated flexible mold piece deformation actuator.

47. A mold deformation apparatus as described in claim 46, further comprising a flexible mold piece joined to said automated flexible mold piece tension induction element.

48. A method for deforming a mold comprising the steps of:
defining a mold zone;
applying a tensile force through said mold zone;
affecting said mold zone as a function of said applied tensile force;
establishing said affected mold zone in an initial geometric configuration;
automatically applying a geometric reconfiguration force to said affected mold zone;
altering said initial geometric configuration of said affected mold zone as a function of said automatically applied geometric reconfiguration force.

49. A method for deforming a mold as described in claim 48, wherein said step of defining a mold zone comprises the step of establishing said mold zone on a flexible mold piece.

50. A method for deforming a mold as described in claim 48, wherein said step of applying a tensile force through said mold zone comprises the step of laterally expanding said mold zone.

51. A method for deforming a mold as described in claim 48, wherein said step of applying a tensile force through said mold zone comprises the steps of:
joining a flexible tie to said mold zone; and
applying a lateral force through said flexible tie.

52. A method for deforming a mold as described in claim 5 1, wherein said step of joining a flexible tie to said mold zone comprises the steps of:
joining a first end of said flexible tie to a first force opposed location of said mold zone; and
joining a second end of said flexible tie to a second force opposed location of said mold zone.

53. A method for deforming a mold as described in claim 48, wherein said step of affecting said mold zone as a function of said applied tensile force comprises the step of increasing the rigidity of said mold zone.

54. A method for deforming a mold as described in claim 48, wherein said step of establishing said affected mold zone in an initial geometric configuration comprises the step of establishing said affected mold zone in a substantially planar configuration.

55. A method for deforming a mold as described in claim 48, wherein said step of automatically applying a geometric reconfiguration force to said affected mold zone comprises the step of deforming said affected mold zone.

56. A method for deforming a mold as described in claim 55, wherein said step of deforming said affected mold zone comprises the step of conforming said affected mold zone to a deformation surface.

57. A method for deforming a mold as described in claim 56, wherein said step of conforming said affected mold zone to a deformation surface comprises the step of conforming said affected mold zone to a curved deformation surface.

58. A method for deforming a mold as described in claim 48, wherein said step of automatically applying a geometric reconfiguration force to said affected mold zone comprises the step of automatically applying a geometric reconfiguration force at a location of said affected mold zone, and further comprising the step of moving said location at which said geometric reconfiguration force is automatically applied.

59. A method for deforming a mold as described in claim 58, wherein said step of moving said location at which said geometric reconfiguration force is automatically applied comprises the step of moving said location at a deformation interface.

60. A method for deforming a mold as described in claim 59, wherein said step of moving said location at a deformation interface comprises the step of generating differential motion at said deformation interface.

61. A method for deforming a mold as described in claim 59, wherein said step of moving said location at a deformation interface comprises the step of generating concurrent motion at said deformation interface.

62. A method for deforming a mold as described in claim 59, wherein said step of moving said location at a deformation interface comprises the step of moving said location about a curved deformation surface.

63. A method for deforming a mold as described in claim 62, wherein said step of moving said location about a curved deformation surface comprises the step of rotating said curved deformation surface.

64. A method for deforming a mold as described in claim 63, wherein said step of rotating said curved deformation surface comprises the step of permitting a free rotation of said curved deformation surface.

65. A method for deforming a mold as described in claim 63, wherein said step of rotating said curved deformation surface comprises the step of driving a rotation of said curved deformation surface.

66. A method for deforming a mold as described in claim 48, wherein said step of altering said initial geometric configuration of said affected mold zone as a function of said automatically applied geometric reconfiguration force comprises the step of flexing said affected mold zone.

67. A method for deforming a mold as described in claim 48, further comprising the steps of:
adding a mold material to said mold zone;
removing a molded material from said mold zone; and
forming a molded product.

68. A method for deforming a mold as described in claim 67, further comprising the steps of:
situating said mold zone at a delivery path location;
moving said mold zone along a delivery path to a mold separation station;
returning said mold zone along said delivery path to said delivery path location;
refilling said mold zone with a mold material.

69. A method for deforming a mold as described in claim 68, wherein said steps of adding a mold material to said mold zone and refilling said mold zone with a mold material comprise the steps of conveying a mold material to said delivery path location.

70. A method for deforming a mold as described in claim 68, further comprising the step of conveying heat to said delivery path location.

71. A method for deforming a mold as described in claim 68, wherein said step of situating said mold zone at a delivery path location comprises the step of situating said mold zone at a conveyor element location, and wherein said step of moving said mold zone along a delivery path to a mold separation station comprises the step of moving said mold zone along said conveyor element to said mold separation station, and wherein said step of returning said mold zone along said delivery path to said delivery path location comprises the step of returning said mold zone along said conveyor element to said conveyor element location.

72. A method for deforming a mold as described in claim 71, wherein said step of situating said mold zone at a conveyor element location comprises the step of situating a first mold zone at a lower conveyor element location and a second mold zone at an upper conveyor element location, and wherein said step of moving said mold zone along said conveyor element to said mold separation station comprises the step of moving said first mold zone along a lower conveyor element to a first mold separation station and moving said second mold zone along an upper conveyor element to a second mold separation station, and wherein said step of returning said mold zone along said conveyor element to said conveyor element location comprises the step of returning said first mold zone along said lower conveyor element to said lower conveyor element location and returning said second mold zone along said upper conveyor element to said upper conveyor element location.

73. A method for deforming a mold as described in claim 71, further comprising the step of permitting a free movement of said conveyor element.

74. A method for deforming a mold as described in claim 71, further comprising the step of driving a movement of said conveyor element.

75-225. (canceled)
